(19) United States
(12) Patent Application Publication
(10) Pub. No.: US 2009/0327383 A1
(43) Pub. Date: Dec. 31, 2009

(54) SINUSOIDAL WAVE GENERATION CIRCUIT

(75) Inventor: Naoki Takahashi, Tokyo (JP)

Correspondence Address: CONNOLLY BOVE LODGE & HUTZ LLP, 1875 EYE STREET, N.W., SUITE 1100, WASHINGTON, DC, 20006, US

(73) Assignees: NSC Co., Ltd., Tokyo (JP); Ricoh Co., Ltd., Tokyo (JP)

(21) Appl. No.: 12/518,546

(22) PCT Filed: Nov. 30, 2007
(86) PCT No.: PCT/JP2007/073625

§ 371 Date: Jun. 10, 2009

(30) Foreign Application Priority Data
Dec. 11, 2006 (JP) 2006-333040

(51) Int. Cl. G06F 1/02

(52) U.S. Cl. 708/276

(57) ABSTRACT

There are provided a coefficient ROM 1 for storing coefficients representing angular frequencies corresponding to a desired frequency and a sampling frequency, that is, two types of coefficients for a single desired frequency, an accumulated addition calculating portion 2 for using one of the coefficients until an accumulated addition value does not exceed a threshold and using the other coefficient when the accumulated addition value exceeds the threshold, thereby adding coefficient values stored in the coefficient ROM 1 every sampling frequency sequentially to obtain an angular frequency for each sample point, and a CORDIC 3 for calculating an amplitude of a sinusoidal wave corresponding to the angular frequency for each sample point which is obtained by the accumulated addition calculating portion 2, thereby generating a sinusoidal wave signal having a desired frequency, and the sinusoidal wave signal having the desired frequency can be generated by a digital calculation from only the two types of coefficients.

### TECHNICAL FIELD

The present invention relates to a sinusoidal wave generation circuit and more particularly to a circuit for digitally generating a sinusoidal wave by using a coefficient stored in a memory.

### BACKGROUND ART

In various electronic apparatuses including a wireless communication apparatus, generally, a sinusoidal wave is often utilized in a signal processing. For example, in a frequency modulation of an FM stereo type to be used in an FM broadcast, a subcarrier of 38 kHz is subjected to a balanced modulation through a left and right difference signal and is converted into a frequency band exceeding 19 kHz. Then, the modulated signal and a pilot signal of 19 kHz are multiplexed with a right and left sum signal and are frequency modulated. The subcarrier signal of 38 kHz and the pilot signal of 19 kHz which are utilized herein are sinusoidal wave signals.

In many cases, the subcarrier signal and the pilot signal are generated through a frequency division of a reference frequency signal (for example, see Patent Document 1). In the Patent Document 1, a reference signal of 76 kHz generated by a crystal resonator is frequency divided into a half through a frequency divider so that a subcarrier signal of 38 kHz is generated. Furthermore, the subcarrier signal is frequency divided into a half so that a pilot signal of 19 kHz is generated.

Moreover, there is also a technique for digitally generating a sinusoidal wave (generating sinusoidal wave digital data) by using a sinusoidal wave look-up table stored in an ROM (for example, see Patent Documents 2 to 4).

Patent Document 1: Japanese Laid-Open Patent Publication No. 9-321720

Patent Document 2: Japanese Laid-Open Patent Publication No. 5-283937

Patent Document 3: Japanese Laid-Open Patent Publication No. 9-186588

Patent Document 4: Japanese Laid-Open Patent Publication No. 11-88056

### DISCLOSURE OF THE INVENTION

In the case in which a sinusoidal wave is generated by a frequency division as described in the Patent Document 1, a frequency which can be generated is limited by a frequency of a crystal oscillator which is a reference. On the other hand, in the case in which a sinusoidal wave is digitally generated as described in the Patent Documents 2 to 4, it is theoretically possible to generate a sinusoidal wave having any frequency by properly setting a table value stored in an ROM.

However, in the prior art using a look-up table, there is a problem in that a data volume to be stored in the ROM is increased and a scale is thus enlarged on a hardware basis. For example, in the case in which a pilot signal of 19 kHz is to be simply generated by setting a sampling frequency to be 240 kHz, 240×19=4560 table values are required for the look-up table so that a capacity of the ROM to be prepared is increased very greatly.

By preparing only a table value corresponding to 0° to 90° of a sinusoidal wave, carrying out turn-up symmetrically with respect to a Y axis within a range of 90° to 180°, carrying out turn-up symmetrically with respect to X and Y axes within a range of 180° to 270° and carrying out turn-up symmetrically with respect to the X axis within a range of 270° to 360°, it is also possible to generate a sinusoidal wave corresponding to 360° in a data volume of ¼. However, also in this case, 1140 table values are required and a capacity of the ROM which is to be prepared is increased.

The present invention has been made to solve the problems and has an object to enable a digital generation of a sinusoidal wave in a small ROM capacity.

In order to attain the object, the present invention includes a coefficient memory for storing coefficients representing angular frequencies corresponding to a desired frequency and a sampling frequency, that is, two types of coefficients for a single desired frequency, an accumulated addition calculating portion for using one of the coefficients until an accumulated addition value does not exceed a threshold and using the other coefficient when the accumulated addition value exceeds the threshold, thereby adding coefficient values stored in the coefficient memory every sampling frequency sequentially to obtain an angular frequency for each sample point, and a trigonometric function calculating portion for calculating an amplitude of a sinusoidal wave corresponding to the angular frequency for each sample point which is obtained by the accumulated addition calculating portion, thereby generating the sinusoidal wave signal having the desired frequency.

In another aspect of the present invention, the trigonometric function calculating portion calculates amplitudes of a sinusoidal wave and a cosine wave which correspond to the angular frequency for each sample point obtained by the accumulated addition calculating portion, thereby generating the sinusoidal wave signal having the desired frequency and a cosine wave signal, and there is provided a calculating portion for utilizing the sinusoidal wave signal and the cosine wave signal which are output from the trigonometric function calculating portion, thereby generating a sinusoidal wave signal having a frequency which is n times as high as the desired frequency in accordance with a formula for an n-fold angle of the trigonometric function.

According to the present invention having the structure described above, it is possible to generate the sinusoidal wave signal having the desired frequency through the digital calculation by only the two types of coefficients. Consequently, as compared with the case in which the sinusoidal wave signal having the desired frequency is generated by the look-up table, it is possible to considerably lessen a capacity of a coefficient ROM and to reduce a scale on a hardware basis.

According to a further feature of the present invention, it is possible to easily obtain the sinusoidal wave signal having the frequency which is n times as high as the desired frequency by simply carrying out a calculation for an n-fold angle of a trigonometric function using the sinusoidal wave signal having the desired frequency which is acquired by the digital calculation with only the two types of coefficients. Consequently, as compared with the case in which the sinusoidal wave signal having the n-fold frequency is generated through the look-up table, it is possible to considerably lessen a capacity of a coefficient ROM, thereby reducing a scale on a hardware basis.

### BRIEF DESCRIPTION OF THE DRAWINGS

FIG. 1 is a diagram showing an example of a structure of a sinusoidal wave generation circuit according to a first embodiment.

FIG. 2 is a diagram showing an example of an operation of an accumulated addition calculating portion according to first and second embodiments.

FIG. 3 is a diagram showing an example of a structure of a sinusoidal wave generation circuit according to the second embodiment.

### BEST MODE FOR CARRYING OUT THE INVENTION

### First Embodiment

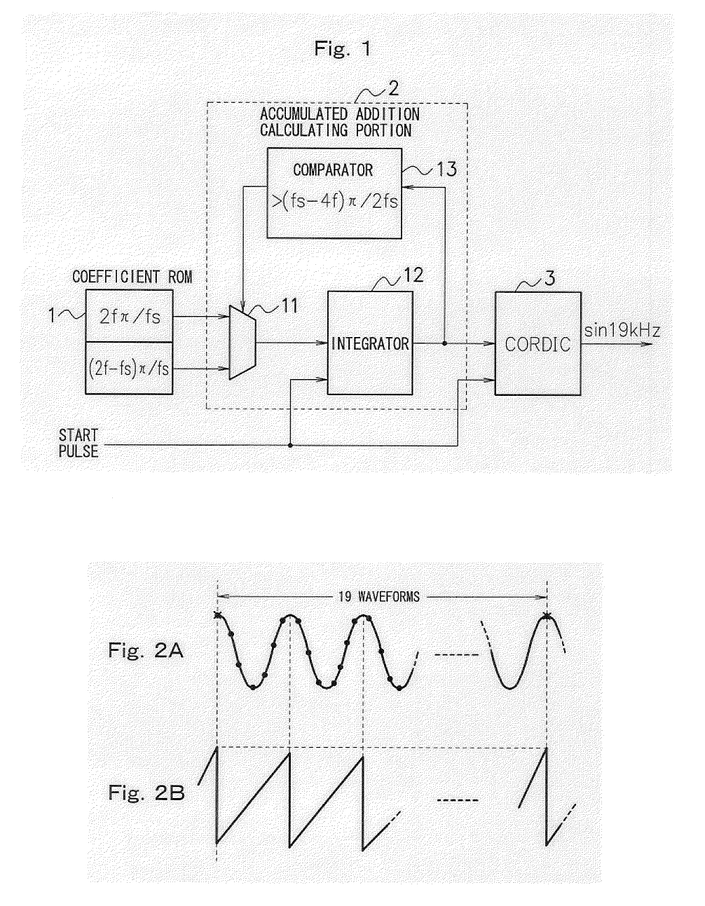

An embodiment according to the present invention will be described below with reference to the drawings. FIG. 1 is a diagram showing an example of a structure of a sinusoidal wave generation circuit according to a first embodiment. As shown in FIG. 1, the sinusoidal wave generation circuit according to the first embodiment includes a coefficient ROM 1, an accumulated addition calculating portion 2 and a CORDIC (Coordinate Rotation Digital Computer) 3. A start pulse for an integrator 12 provided in the accumulated addition calculating portion 2 and the CORDIC 3 is input at an interval of a sampling frequency fs.

The coefficient ROM 1 is equivalent to a coefficient memory according to the present invention and stores coefficients representing angular frequencies corresponding to a desired frequency f (a frequency of a sinusoidal wave signal which is to be obtained) and the sampling frequency fs (fs>2f and fs>>2f are preferred), that is, two types of coefficients for the single desired frequency f. One of the two types of coefficients is represented by 2fπ/fs and the other coefficient is represented by (2f−fs)π/fs. In the present embodiment, the sinusoidal wave signal to be obtained is a pilot signal, and a frequency f thereof is 19 kHz and a sampling frequency fs is 240 kHz.

The accumulated addition calculating portion 2 serves to sequentially add a coefficient value stored in the coefficient ROM 1 for each sampling frequency fs and to obtain an accumulated addition value of an angular frequency. The accumulated addition calculating portion 2 uses one of two types of coefficients stored in the coefficient ROM 1, that is, {2fπ/fs)} until the accumulated addition value does not exceed a threshold and uses the other coefficient {(2f−fs)π/fs) when the accumulated addition value exceeds the threshold, and sequentially adds the coefficient value stored in the coefficient ROM 1 every sampling frequency fs, thereby obtaining an angular frequency for each sample point.

The accumulated addition calculating portion 2 is constituted by a selector 11, the integrator 12 and a comparator 13. The selector 11 selects either of the two types of coefficients stored in the coefficient ROM 1 and outputs the coefficient thus selected to the integrator 12. The integrator 12 sequentially adds the coefficient supplied from the selector 11, thereby obtaining an accumulated addition value of an angular frequency. The accumulated addition value thus obtained is output to the CORDIC 3 and the comparator 13.

The comparator 13 compares the accumulated addition value of the angular frequency which is supplied from the integrator 12 with a predetermined threshold, and outputs a signal corresponding to a result of the comparison to a control terminal of the selector 11. Herein, the predetermined threshold is set to be (fs−4f)π/2fs (fs>4f). The selector 11 selects the coefficient {2fπ/fs} when a comparison signal indicating that the accumulated addition value of the angular frequency supplied from the integrator 12 is equal to or smaller than the threshold is supplied from the comparator 13. Moreover, the selector 11 selects the other coefficient {(2f−fs)π/fs} when a comparison signal indicating that the accumulated addition value is greater than the threshold is supplied from the comparator 13.

FIG. 2A and 2B are diagrams showing an example of an operation of the accumulated addition calculating portion 2 having the structure described above. FIG. 2A shows an analog pilot signal of 19 kHz for reference and FIG. 2B shows an example of an operation of the accumulated addition calculating portion 2. In FIG. 2A, a black circle represents each sample point. In case of 19 kHz, an amplitude value of the sample point in the analog pilot signal is returned to be the same value with 19 waveforms set into one cycle (one cycle is 1 msec).

The accumulated addition calculating portion 2 sequentially adds the coefficient {2fπ/fs} for each sampling frequency fs. Therefore, the accumulated addition value of the angular frequency is gradually increased at a certain rate as shown in FIG. 2B. When the accumulated addition value exceeds the predetermined threshold {(fs−4f)π/2fs}, a value to be added is changed into the other coefficient {(2f−fs)π/fs} by the selector 11.

The sampling frequency fs is sufficiently greater than the desired frequency f at f=19 kHz and fs=240 kHz (2f<<fs). Accordingly, the other coefficient has a negative value and an absolute value thereof is sufficiently greater than the threshold. Therefore, the accumulated addition value is decreased to be small at a stroke as shown in FIG. 2B through the addition of the other coefficient {(2f−fs)π/fs}. Then, the coefficient {2fπ/fs} is sequentially added again. Therefore, the accumulated addition value is increased again. When the operation is repeated 19 times, the accumulated addition value is returned to be the same value 19 sample points before.

The CORDIC 3 is equivalent to a trigonometric function calculating portion according to the present invention and calculates an amplitude of a sinusoidal wave corresponding to an angular frequency for each sample point which is obtained by the accumulated addition calculating portion 2, thereby generating a sinusoidal wave signal having a desired frequency (a pilot signal of 19 kHz). This corresponds to a generation of a sinusoidal wave signal having a waveform shown in FIG. 2A from data on a waveform shown in FIG. 2B.

The CORDIC 3 can obtain a value of a trigonometric function by repeating a calculation through a shift, an addition and subtraction and a read of a constant from a table in accordance with an algorithm for implementing a plane rotation of a two-dimensional vector through an elementary function calculation such as the trigonometric function, a multiplication or a division. For example, by setting a point P₀(1, 0) on an x axis as a reference point to obtain coordinates of a point P(x, y) acquired through a rotation by an angular frequency on a certain sample point, it is possible to obtain a y coordinate as a value of a sin function corresponding to the angular frequency, that is, an amplitude of a sinusoidal wave signal which is to be acquired. If the calculation is carried out for each sample point, it is possible to generate the sinusoidal wave signal having the waveform shown in FIG. 2A.

As described above in detail, according to the first embodiment, it is possible to generate a pilot signal based on the sinusoidal wave of 19 kHz through the digital calculation from only the two types of coefficients stored in the coefficient ROM 1. Consequently, as compared with the case in which the sinusoidal wave signal having the desired frequency is conventionally generated through the look-up table, it is possible to considerably lessen the capacity of the coefficient ROM 1, thereby reducing a hardware scale.

### Second Embodiment

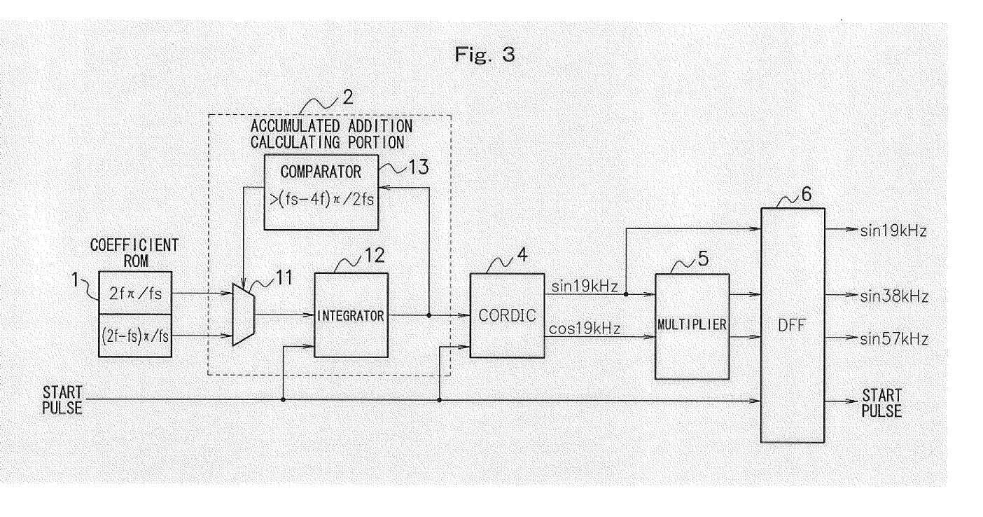

Next, description will be given to a second embodiment according to the present invention. FIG. 3 is a diagram showing an example of a structure of a sinusoidal wave generation circuit according to the second embodiment. In FIG. 3, components having the same reference numerals as those shown in FIG. 1 have the same functions and repetitive description will be therefore omitted. As shown in FIG. 3, the sinusoidal wave generation circuit according to the second embodiment includes a coefficient ROM 1, an accumulated addition calculating portion 2, a CORDIC 4, a multiplier 5 and a D type flip flop 6.

The CORDIC 4 calculates amplitudes of a sinusoidal wave and a cosine wave which correspond to an angular frequency for each sample point that is obtained by the accumulated addition calculating portion 2, thereby generating a sinusoidal wave signal (sinf) of 19 kHz and a cosine wave signal (cosf). The multiplier 5 is equivalent to the calculating portion according to the present invention and utilizes the sinusoidal wave signal and the cosine wave signal which are output from the CORDIC 4, thereby generating a sinusoidal wave signal having a frequency which is n times as high as 19 kHz in accordance with a formula of an n-fold angle (n is an integer of two or more) of a trigonometric function.

Herein, a sinusoidal wave signal (sin2f) having a double frequency and a sinusoidal wave signal (sin3f) having a triple frequency are generated. A sinusoidal wave signal of 38 kHz is used as a subcarrier signal of an FM stereo modulation, for example. For instance, in case of an electronic apparatus having a transmitter function for FM stereo modulating a reproduced audio signal and transmitting the signal by wireless, a pilot signal of 19 kHz and a subcarrier signal of 38 kHz are used.

Moreover, a sinusoidal wave signal of 57 kHz is used as a subcarrier signal of an RDS (Radio Data System), for example. The RDS can put data on an FM radio broadcasting signal and can deliver the data, and can thus display, on a display, information about a name of a tune which is being heard, a name of an artist, a radio station or the like in an electronic apparatus receiving the data. It can also be supposed that a recent electronic apparatus is advanced to be multifunctional and each function of an RDS, an FM stereo modulation or the like is mounted on a single electronic apparatus (for example, a portable telephone). In that case, there are used all of the pilot signal of 19 kHz, the subcarrier signal of 38 kHz and a subcarrier signal of 57 kHz.

The D type flip flop 6 arranges timings of the pilot signal (sinf) of 19 kHz, the subcarrier signal (sin2f) of 38 kHz and the subcarrier signal (sin3f) of 57 kHz, and outputs the signals.

As described above in detail, according to the second embodiment, it is possible to generate a pilot signal of 19 kHz, a stereo subcarrier signal of 38 kHz and an RDS subcarrier signal of 57 kHz through a digital calculation from only two types of coefficients stored in the coefficient ROM 1. It is possible to easily obtain the sinusoidal wave signal having the n-fold frequency by using a sinusoidal wave signal having a desired frequency acquired through a digital calculation from only two types of coefficients to simply carry out a calculation for an n-fold angle of a trigonometric function. Consequently, as compared with the case in which sinusoidal wave signals having a desired frequency and an n-fold frequency thereof are generated through a look-up table, it is possible to considerably lessen a capacity of the coefficient ROM 1, thereby reducing a hardware scale.

Although the description has been given to the example in which f=19 kHz and fs=240 kHz are set in the first and second embodiments, it is only illustrative. By changing values of f and fs, it is possible to easily obtain a sinusoidal wave signal having an optional frequency through a digital calculation.

Moreover, a sinusoidal wave signal having a single desired frequency can be obtained from two coefficients. Therefore, m (m is an integer of two or more) sinusoidal wave signals having desired frequencies can be obtained from 2m coefficients. For example, if two types of coefficients of {2f₁π/fs} and {(2f₁−fs)π/fs} are prepared to obtain a sinusoidal wave signal having a certain desired frequency f₁ and two types of coefficients of {2f₂π/fs} and {(2f₂−fs)π/fs} are prepared to obtain a sinusoidal wave signal having another desired frequency f₂, it is possible to generate the two sinusoidal wave signals having the desired frequencies f₁ and f₂ from these four types of coefficients.

Although the description has been given to the example in which the sinusoidal wave signal is generated by using the coefficient of the coefficient ROM 1 in the first and second embodiments, it is apparent that a cosine wave signal can be generated by the same processing.

In addition, the first and second embodiments are only illustrative for a concreteness to carry out the present invention and the technical range of the present invention should not be thereby construed to be restrictive. In other words, the present invention can be carried out in various forms without departing from the spirit or main features thereof.

### INDUSTRIAL APPLICABILITY

A sinusoidal wave generation circuit according to the present invention is widely useful for a circuit and an apparatus which carry out a processing by using a sinusoidal wave signal. An oscillator, a frequency synthesizer, a radio receiver, an FM transmitter, an electronic musical instrument or the like is taken as an example.

This application is based on Japanese Patent Application No. 2006-333040 filed on Dec. 11, 2006, the contents of which are incorporated hereinto by reference.

1. A sinusoidal wave generation circuit for digitally generating a sinusoidal wave signal having a desired frequency, comprising:
a coefficient memory for storing coefficients representing angular frequencies corresponding to the desired frequency and a sampling frequency, that is, two types of frequencies for a single desired frequency;
an accumulated addition calculating portion for using one of the two types of coefficients until an accumulated addition value does not exceed a threshold and using the other coefficient when the accumulated addition value exceeds the threshold, thereby adding coefficient values stored in the coefficient memory every sampling frequency sequentially to obtain an angular frequency for each sample point; and
a trigonometric function calculating portion for calculating an amplitude of a sinusoidal wave corresponding to the angular frequency for each sample point which is obtained by the accumulated addition calculating portion, thereby generating the sinusoidal wave signal having the desired frequency.

2. The sinusoidal wave generation circuit according to claim 1, wherein the trigonometric function calculating portion calculates amplitudes of a sinusoidal wave and a cosine wave which correspond to the angular frequency for each sample point obtained by the accumulated addition calculating portion, thereby generating the sinusoidal wave signal and a cosine wave signal each having the desired frequency, and
there is provided a calculating portion for utilizing the sinusoidal wave signal and the cosine wave signal which are output from the trigonometric function calculating portion, thereby generating a sinusoidal wave signal having a frequency which is n times as high as the desired frequency in accordance with a formula for an n-fold angle of the trigonometric function.

3. The sinusoidal wave generation circuit according to claim 1, wherein the desired frequency is represented by f and the sampling frequency is represented by fs(fs>2f), and one of the coefficients is indicated as 2fπ/fs and the other coefficient is indicated as (2f−fs)π/fs.

4. The sinusoidal wave generation circuit according to claim 3, wherein the threshold is indicated as (fs−4f)π/2fs (fs>4f).

5. The sinusoidal wave generation circuit according to claim 2, wherein the desired frequency is represented by f and the sampling frequency is represented by fs(fs>2f), and one of the coefficients is indicated as 2fπ/fs and the other coefficient is indicated as (2f−fs)π/fs.

6. The sinusoidal wave generation circuit according to claim 5, wherein the threshold is indicated as (fs−4f)π/2fs (fs>4f).
